(19) United States
(12) Patent Application Publication
(10) Pub. No.: US 2017/0329855 A1
(43) Pub. Date: Nov. 16, 2017

(54) METHOD AND DEVICE FOR PROVIDING CONTENT

(71) Applicant: Samsung Electronics Co., Ltd., Suwon-si, Gyeonggi-do (KR)

(72) Inventors: Jong-hyun RYU, Suwon-si (KR); Han-joo CHAE, Seoul (KR); Sang-ok CHA, Suwon-si (KR); Won-young CHOI, Seoul (KR)

(21) Appl. No.: 15/532,285

(22) PCT Filed: Nov. 27, 2015
(86) PCT No.: PCT/KR2015/012848

§ 371 Date: Jun. 1, 2017

(30) Foreign Application Priority Data
Dec. 1, 2014 (KR) 10-2014-0169968

(51) Int. Cl. G06F 17/30; G06F 19/00

(52) U.S. Cl. CPC G06F 17/30867; G06F 19/345

(57) ABSTRACT

Provided is a method of providing content, via a device, the method including: obtaining bio-information of a user using content executed on the device, and context information indicating a situation of the user at a point of obtaining the bio-information of the user; determining an emotion of the user using the content, based on the obtained bio-information of the user and the obtained context information; extracting at least one portion of content corresponding to the emotion of the user that satisfies a predetermined condition; and generating content summary information including the extracted at least one portion of content, and emotion information corresponding to the extracted at least one portion of content.

### TECHNICAL FIELD

The present inventive concept relates to a method and device for providing content.

### BACKGROUND ART

Recently, with the development of information and communication technologies and network technologies, devices have developed into multimedia-type portable devices having various functions. Recently, such devices include sensors which can sense bio-signals of a user or signals generated around the devices.

Conventional devices simply perform operations corresponding to user inputs, based on the user inputs. However, in recent times, various applications that are executable on devices have been developed and technologies related to the sensors provided in the devices have advanced, and thus, the amount of user information that may be obtained by the devices has increased. As the amount of user information that may be obtained by the devices has increased, research has been actively conducted into methods of performing, via the devices, operations needed for users by analyzing user information, rather than simply performing operations corresponding to user inputs.

### DETAILED DESCRIPTION OF THE INVENTION

### Technical Problem

Embodiments disclosed herein relate to a method and a device for providing content based on bio-information of a user and a situation of the user.

### Technical Solution

Provided is a method of providing content, via a device, the method including: obtaining bio-information of a user using content executed on the device, and context information indicating a situation of the user at a point of obtaining the bio-information of the user; determining an emotion of the user using the content, based on the obtained bio-information of the user and the obtained context information; extracting at least one portion of content corresponding to the emotion of the user that satisfies a predetermined condition; and generating content summary information including the extracted at least one portion of content, and emotion information corresponding to the extracted at least one portion of content.

### DESCRIPTION OF THE DRAWINGS

FIG. 1 is a conceptual view for describing a method of providing content via a device, according to an embodiment.

FIG. 2 is a flowchart of a method of providing content via a device, according to an embodiment.

FIG. 3 is a flowchart of a method of extracting content data from a portion of content, based on a type of content, via a device, according to an embodiment.

FIG. 4 is a view for describing a method of selecting at least one portion of content, based on a type of content, via a device, according to an embodiment.

FIG. 5 is a flowchart of a method of generating an emotion information database with respect to a user, via a device, according to an embodiment.

FIG. 6 is a flowchart of a method of providing content summary information with respect to an emotion selected by a user, to the user, via a device, according to an embodiment.

FIG. 7 is a view for describing a method of providing a user interface (UI) via which any one of a plurality of emotions may be selected by a user, to the user, via a device, according to an embodiment.

FIG. 8 is a detailed flowchart of a method of outputting content summary information with respect to content, when the content is re-executed on a device.

FIG. 9 is a view for describing a method of providing content summary information, when an electronic book (e-book) is executed on a device, according to an embodiment.

FIG. 10 is a view for describing a method of providing content summary information, when an e-book is executed on a device, according to another embodiment.

FIG. 11 is a view for describing a method of providing content summary information, when a video is executed on a device, according to an embodiment.

FIG. 12 is a view for describing a method of providing content summary information, when a video is executed on a device, according to another embodiment.

FIG. 13 is a view for describing a method of providing content summary information, when a call application is executed on a device, according to an embodiment.

FIG. 14 is a view for describing a method of providing content summary information with respect to a plurality of pieces of content, by combining portions of content in which specific emotions are felt, from among the plurality of pieces of content, according to an embodiment.

FIG. 15 is a flowchart of a method of providing content summary information of another user with respect to content, via a device, according to an embodiment.

FIG. 16 is a view for describing a method of providing content summary information of another user with respect to content, via a device, according to an embodiment.

FIG. 17 is a view for describing a method of providing content summary information of another user with respect to content, via a device, according to another embodiment.

FIGS. 18 and 19 are block diagrams of a structure of a device according to an embodiment.

### BEST MODE

According to an aspect of the present inventive concept, there is provided a method of providing content, via a device, the method including: obtaining bio-information of a user using content executed on the device, and context information indicating a situation of the user at a point of obtaining the bio-information of the user; determining an emotion of the user using the content, based on the obtained bio-information of the user and the obtained context information of the user; extracting at least one portion of content corresponding to the emotion of the user that satisfies a predetermined condition; and generating content summary information including the extracted at least one portion of content, and emotion information corresponding to the extracted at least one portion of content.

According to another aspect of the present inventive concept, there is provided a device for providing content, the device including: a sensor configured to obtain bio-information of a user using content executed on the device, and context information indicating a situation of the user at a point of obtaining the bio-information of the user; a controller configured to determine an emotion of the user using the content, based on the obtained bio-information of the user and the obtained context information of the user, extract at least one portion of content corresponding to the emotion of the user that satisfies a predetermined condition, and generate content summary information including the extracted at least one portion of content, and emotion information corresponding to the extracted at least one portion of content; and an output unit configured to display the executed content.

### MODE OF THE INVENTION

Hereinafter, the present inventive concept will be described more fully with reference to the accompanying drawings, in which example embodiments of the invention are shown. The invention may, however, be embodied in many different forms and should not be construed as being limited to the embodiments set forth herein; rather these embodiments are provided so that this disclosure will be thorough and complete, and will fully convey the concept of the invention to one of ordinary skill in the art. In the drawings, like reference numerals denote like elements. Also, while describing the present inventive concept, detailed descriptions about related well known functions or configurations that may blur the points of the present inventive concept are omitted.

Throughout the specification, it will be understood that when an element is referred to as being “connected” to another element, it may be “directly connected” to the other element or “electrically connected” to the other element with intervening elements therebetween. It will be further understood that when a part “includes” or “comprises” an element, unless otherwise defined, the part may further include other elements, not excluding the other elements.

In this specification, “content” may denote various information produced, processed, and distributed in a digital method with the sources of texts, signs, voices, sounds, images, etc. to be used in a wired or wireless electrical communication network, or all the content included in the information. The content may include at least one of texts, signs, voices, sounds, and images that are output on a screen of a device when an application is executed. The content may include, for example, an electronic book (e-book), a memo, a picture, a movie, music, etc. However, it is only an embodiment, and the content of the present inventive concept is not limited thereto.

In this specification, “applications” refer to a series of computer programs for performing specific operations. The applications described in this specification may vary. For example, the applications may include a camera application, a music-playing application, a game application, a video-playing application, a map application, a memo application, a diary application, a phone-book application, a broadcasting application, an exercise assistance application, a payment application, a photo folder application, etc. However, the applications are not limited thereto.

“Bio-information” refers to information about bio-signals generated from a human body of a user. For example, the bio-information may include a pulse rate, blood pressure, an amount of sweat, a body temperature, a size of a sweat gland, a facial expression, a size of a pupil, etc. of the user. However, this is only an embodiment, and the bio-information of the present inventive concept is not limited thereto.

“Context information” may include information with respect to a situation of a user using a device. For example, the context information may include a location of the user, a temperature, a volume of noise, and a brightness of the location of the user, a body part of the user wearing the device, or a performance of the user while using the device. The device may predict the situation of the user via the context information. However, this is only an embodiment, and the context information of the present inventive concept is not limited thereto.

“An emotion of a user using content” refers to a mental response of the user using the content toward the content. The emotion of the user may include mental responses, such as boredom, interest, fear, or sadness. However, this is only an embodiment, and the emotion of the present inventive concept is not limited thereto.

Hereinafter, the present inventive concept will be described in detail by referring to the accompanying drawings.

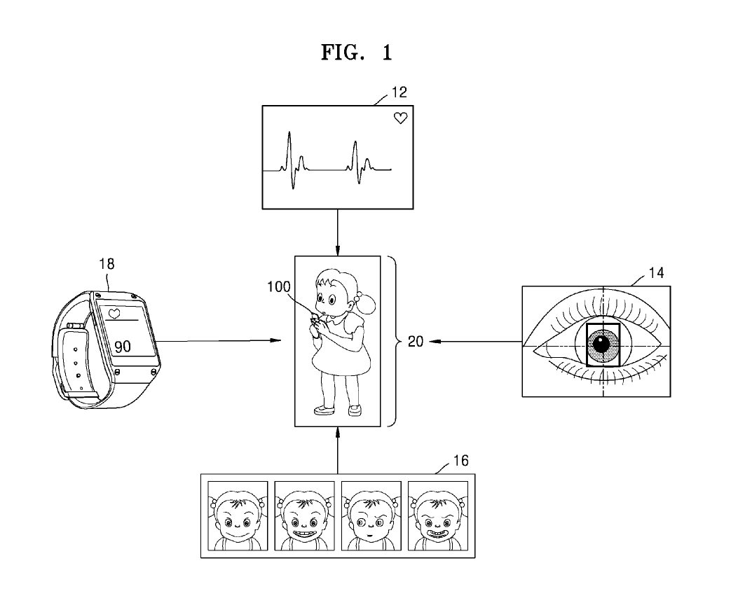

FIG. 1 is a conceptual view for describing a method of providing content via a device 100, according to an embodiment.

The device 100 may output at least one piece of content on the device 100, according to an application that is executed. For example, when a video application is executed, the device 100 may output content in which images, text, signs, and sounds are combined, on the device 100, by playing a movie file.

The device 100 may obtain information related to a user using the content, by using at least one sensor. The information related to the user may include at least one of bio-information of the user and context information of the user. For example, the device 100 may obtain the bio-information of the user, which includes an electrocardiogram (ECG) 12, a size of a pupil 14, a facial expression of the user, a pulse rate 18, etc. Also, the device 100 may obtain the context information indicating a situation of the user.

The device 100 according to an embodiment may determine an emotion of the user with respect to the content, in a situation determined based on the context information. For example, the device 100 may determine a temperature around the user by using the context information. The device 100 may determine the emotion of the user based on the amount of sweat produced by the user at the determined temperature around the user.

In detail, the device 100 may determine whether the user has a feeling of fear, by comparing an amount of sweat, which is a reference for determining whether the user feels scared, with the amount of sweat produced by the user. Hereby, the reference amount of sweat for determining whether the user feels scared when watching a movie may be set to be different between when a temperature of an environment of the user is high and when the temperature of the environment of the user is low.

The device 100 may generate content summary information corresponding to the determined emotion of the user. The content summary information may include a plurality of portions of content included in the content that the user uses, the plurality of portions of content being classified based on emotions of the user. Also, the content summary information may also include emotion information indicating emotions of the user, which correspond to the plurality of classified portions of content. For example, the content summary information may include the portions of content at which the user feels scared while using the content with the emotion information indicating fear. The device 100 may capture scenes 1 through 10 of movie A that the user is watching and at which the user feels scared, and combine the captured scenes 1 through 10 with the emotion information indicating fear to generate the content summary information.

The device 100 may be a smartphone, a cellular phone, a personal digital assistant (PDA), a laptop media player, a global positioning system (GPS) device, a laptop computer, or other mobile or non-mobile computing devices, but is not limited thereto.

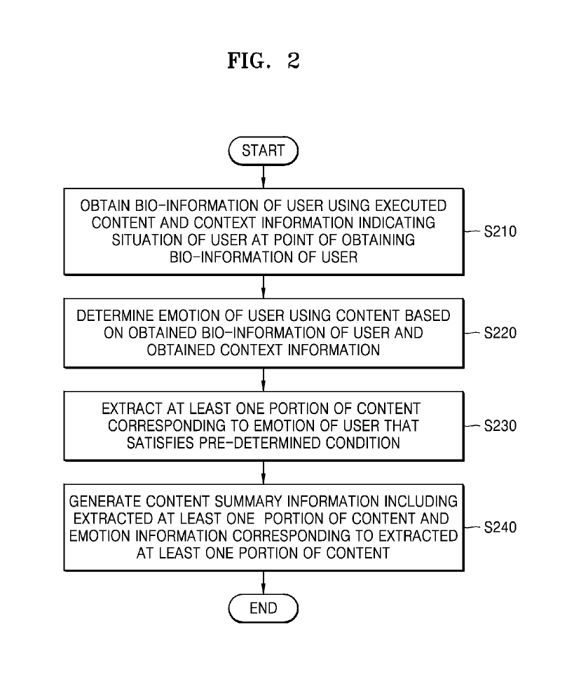

FIG. 2 is a flowchart of a method of providing content via the device 100, according to an embodiment.

In operation S210, the device 100 may obtain bio-information of a user using content executed on the device 100, and context information indicating a situation of the user at a point of obtaining the bio-information of the user.

The device 100 according to an embodiment may obtain the bio-information including at least one of a pulse rate, a blood pressure, an amount of sweat, a body temperature, a size of a sweat gland, a facial expression, and a size of a pupil of the user using the content. For example, the device 100 may obtain information indicating that the size of the pupil of the user is x and the body temperature of the user is y.

The device 100 may obtain the context information including a location of the user, and at least one of weather, a temperature, an amount of sunlight, and humidity of the location of the user. The device 100 may determine a situation of the user by using the obtained context information.

For example, the device 100 may obtain the information indicating that the temperature at the location of the user is z. The device 100 may determine whether the user is indoors or outdoors by using the information about the temperature of the location of the user. Also, the device 100 may determine an extent of change in the location of the user with time, based on the context information. The device 100 may determine movement of the user, such as whether the user is moving or not, by using the extent of change in the location of the user with time.

The device 100 may store information about the content executed at a point of obtaining the bio-information and the context information, together with the bio-information and the context information. For example, when the user watches a movie, the device 100 may store the bio-information and the context information of the user for each of frames, the number of which is pre-determined.

According to another embodiment, when the obtained bio-information has a difference from bio-information of the user when the user is not using the content, the difference being equal to or greater than a critical value, the device 100 may store the bio-information, the context information, and information about the content executed at the point of obtaining the bio-information and the context information.

In operation S220, the device 100 may determine an emotion of the user using the content, based on the obtained bio-information of the user and the obtained context information. The device 100 may determine the emotion of the user corresponding to the bio-information of the user, by taking into account the situation of the user, indicated by the obtained context information.

The device 100, according to an embodiment, may determine the emotion of the user by comparing the obtained bio-information with reference bio-information for each of a plurality of emotions, in the situation of the user. Here, the reference bio-information may include various types of bio-information that are references for a plurality of emotions, and numerical values of the bio-information. The reference bio-information may vary based on situations of the user.

When the obtained bio-information corresponds to the reference bio-information, the device 100 may determine an emotion associated with the reference bio-information, as the emotion of the user. For example, when the user watches a movie at a temperature that is higher than an average temperature by two degrees, the reference bio-information with respect to fear may be set as a condition in which the pupil increases by 1.05 times or more and the body temperature increases by 0.5 degrees or higher. The device 100 may determine whether the user feels scared, by determining whether the obtained size of the pupil and the obtained body temperature of the user satisfy the predetermined range of the reference bio-information.

As another example, when the user watches a movie file while walking outdoors, the device 100 may change the reference bio-information, by taking into account the situation in which the user is moving. When the user watches the movie file while walking outdoors, the device 100 may select the reference bio-information associated with fear as a pulse rate between 130 and 140. The device 100 may determine whether the user feels scared, by determining whether an obtained pulse rate of the user is between 130 and 140.

In operation S230, the device 100 may extract at least one portion of content corresponding to the emotion of the user that satisfies the pre-determined condition. Here, the pre-determined condition may include types of emotions or degrees of emotions. The types of emotions may include fear, joy, interest, sadness, boredom, etc. Also, the degrees of emotions may be divided according to an extent to which the user feels any one of the emotions. For example, the emotion of fear that the user feels may be divided into a slight fear or a great fear. As a reference for dividing the degrees of emotions, bio-information of the user may be used. For example, when the reference bio-information with respect to a pulse rate of a user feeling the emotion of fear is between 130 and 140, the device 100 may divide the degree of the emotion of fear such that the pulse rate between 130 and 135 is a slight fear and the pulse rate between 135 and 140 is great fear.

Also, a portion of content may be a data unit forming the content. The portion of content may vary according to types of content. When the content is a movie, the portion of content may be generated by dividing the content with time. For example, when the content is a movie, the portion of content may be at least one frame forming the movie. However, this is only an embodiment, and this aspect may be applied in the same manner to the content in which data that is output is changed with time.

As another example, when the content is a photo, the portion of content may be images included in the photo. As another example, when the content is an e-book, the portion of content may be sentences, paragraphs, or pages included in the e-book.

When the device 100 receives an input of selecting a specific emotion from the user, the device 100 may select a predetermined condition for the specific emotion. For example, when the user selects an emotion of fear, the device 100 may select the predetermined condition for the emotion of fear, namely, a pulse rate between 130 and 140. The device 100 may extract a portion of content satisfying the selected condition from among a plurality of portions of content included in the content.

According to an embodiment, the device 100 may detect at least one piece of content related to the selected emotion, from among a plurality of pieces of content stored in the device 100. For example, the device 100 may detect a movie, music, a photo, an e-book, etc. related to fear. When a user selects any one of the detected pieces of content related to fear, the device 100 may extract at least one portion of content with respect to the selected piece of content.

As another example, when the user specifies types of content, the device 100 may output content related to the selected emotion, from among the specified types of content. For example, when the user specifies the type of content as a movie, the device 100 may detect one or more movies related to fear. When the user selects any one of the detected one or more movies related to fear, the device 100 may extract at least one portion of content with respect to the selected movie.

As another example, when any one piece of content is pre-specified, the device 100 may extract at least one portion of content with respect to the selected emotion, from the pre-specified piece of content.

In operation S240, the device 100 may generate content summary information including the extracted at least one portion of content and emotion information corresponding to the extracted at least one portion of content. The device 100 may generate the content summary information by combining a portion of content satisfying a pre-determined condition with respect to fear, and the emotion information of fear. The emotion information according to an embodiment may be indicated by using at least one of text, an image, and a sound. For example, the device 100 may generate the content summary information by combining at least one frame of movie A, the at least one frame being related to fear, and an image indicating a scary expression.

Meanwhile, the device 100 may store the generated content summary information as metadata with respect to the content. The metadata with respect to the content may include information indicating the content. For example, the metadata with respect to the content may include a type, a title, and a play time of the content, and information about at least one emotion that a user feels while using the content. As another example, the device 100 may store emotion information corresponding to a portion of content, as metadata with respect to the portion of content. The metadata with respect to the portion of content may include information for identifying the portion of content in the content. For example, the metadata with respect to the portion of content may include information about a location of the portion of content in the content, a play time of the portion of content, and a play start time of the portion of content, and an emotion that a user feels while using the portion of content.

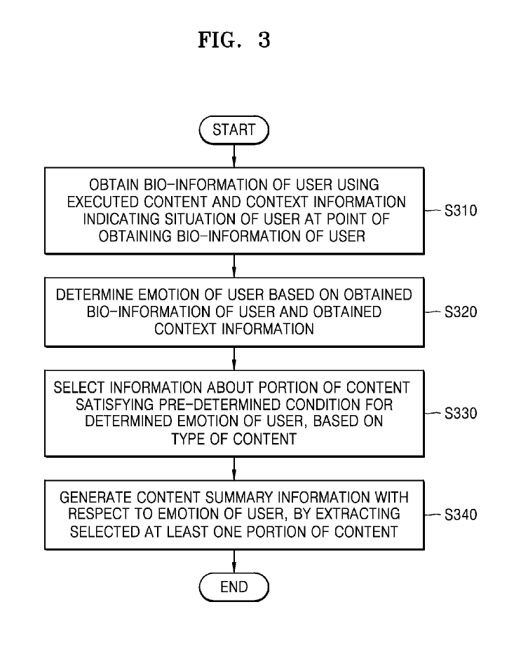

FIG. 3 is a flowchart of a method of extracting content data from a portion of content based on a type of content, via the device 100, according to an embodiment.

In operation S310, the device 100 may obtain bio-information of a user using content executed on the device 100 and context information indicating a situation of the user at a point of obtaining the bio-information of the user.

Operation S310 may correspond to operation S210 described above with reference to FIG. 2.

In operation S320, the device 100 may determine an emotion of the user using the content, based on the obtained bio-information of the user and the obtained context information. The device 100 may determine the emotion of the user corresponding to the bio-information of the user, based on the situation of the user that is indicated by the obtained context information.

Operation S320 may correspond to operation S220 described above with reference to FIG. 2.

In operation S330, the device 100 may select information about a portion of content satisfying a pre-determined condition for the determined emotion of the user, based on a type of content. Types of content may be determined based on information, such as text, a sign, a voice, a sound, an image, etc. included in the content and a type of application via which the content is output. For example, the types of content may include a video, a movie, an e-book, a photo, music, etc.

The device 100 may determine the type of content by using metadata with respect to applications. Identification values for respectively identifying a plurality of applications that are stored in the device 100 may be stored as the metadata with respect to the applications. Also, code numbers, etc. indicating types of content executed in the applications may be stored as the metadata with respect to the applications. The types of content may be determined in any one of operations S310 through S330.

When the type of content is determined as a movie, the device 100 may select at least one frame satisfying a pre-determined condition, from among a plurality of scenes included in the movie. The predetermined condition may include reference bio-information, which includes types of bio-information that are references for a plurality of emotions and numerical values of the bio-information. The bio-information references may vary based on situations of a user. For example, the device 100 may select at least one frame satisfying a pulse rate with respect to fear, in a situation of the user, which is determined based on the context information. As another example, when the type of content is determined as an e-book, the device 100 may select a page which satisfies a pulse rate with respect to fear from among a plurality of pages included in the e-book, or may select some text included in the page. As another example, when the type of content is determined as music, the device 100 may select some played parts satisfying a pulse rate with respect to fear, from among all played parts of the music.

In operation S340, the device 100 may extract the at least one selected portion of content and generate content summary information with respect to an emotion of the user. The device 100 may generate the content summary information by combining the at least one selected portion of content and emotion information corresponding to the at least one selected portion of content.

The device 100 may store the emotion information as metadata with respect to the at least one portion of content. The metadata with respect to the at least one portion of content may include data given to content according to a regular rule for efficiently detecting and using a specific portion of content from among a plurality of portions of content included in content. The metadata with respect to the portion of content may include an identification value, etc. indicating each of the plurality of portions of content. The device 100 according to an embodiment may store the emotion information with the identification value indicating each of the plurality of portions of content.

For example, the device 100 may generate the content summary information with respect to a movie by combining frames of a selected movie and emotion information indicating fear. The metadata with respect to each of the frames may include the identification value indicating the frame and the emotion information. Also, the device 100 may generate the content summary information by combining at least one selected played section of music with emotion information corresponding to the at least one selected played section of music. The metadata with respect to each selected played section of the music may include the identification value indicating the played section and the emotion information.

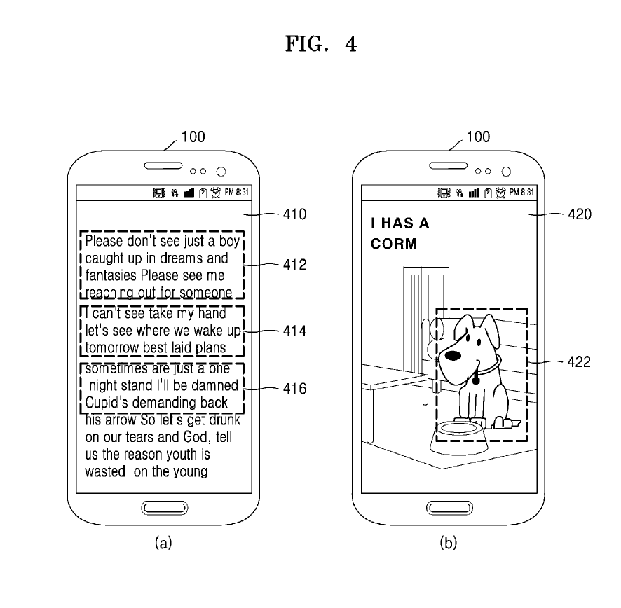

FIG. 4 is a view for describing a method of selecting at least one portion of content, based on a type of content, via the device 100, according to an embodiment.

Referring to (a) of FIG. 4, the device 100 may output an e-book. The device 100 may obtain information that content that is output is the e-book by using metadata with respect to an e-book producing application. For example, the device 100 may obtain the information that the content that is output is the e-book by using an identification value of the e-book application, the identification value being stored in the metadata with respect to the e-book application. The device 100 may select a text portion 414 satisfying a predetermined condition, from among a plurality of text portions 412, 414, and 416 included in the e-book. The device 100 may analyze bio-information and context information of a user using the e-book and determine whether the bio-information satisfies reference bio-information which is set with respect to sadness, in a situation of the user. For example, when brightness of the device 100 is 1, the device 100 may analyze a size of a pupil of the user using the e-book, and when the analyzed size of the pupil of the user is included in a predetermined range of sizes of the pupil with respect to sadness, the device may select the text portion 414 used at a point of obtaining the bio-information.

The device 100 may generate content summary information by combining the selected text portion 414 with emotion information corresponding to the selected text portion 414. The device 100 may generate the content summary information about the e-book by storing the emotion information indicating sadness as metadata with respect to the selected text portion 414.

Referring to (b) of FIG. 4, the device 100 may output a photo 420. The device 100 may obtain information indicating that content that is output is the photo 420 by using an identification value of a photo storage application, the identification value being stored in metadata with respect to the photo storage application.

The device 100 may select an image 422 satisfying a predetermined condition, from among a plurality of images included in the photo 420. The device 100 may analyze bio-information and context information of a user using the photo 420 and determine whether the bio-information satisfies reference bio-information which is set with respect to joy, in a situation of the user. For example, when the user is not moving, the device 100 may analyze a heartbeat of the user using the photo 420, and when the analyzed heartbeat of the user is included in a range of heartbeats which is set with respect to joy, the device 100 may select the image 422 used at a point of obtaining the bio-information.

The device 100 may generate content summary information by combining the selected image 422 with emotion information corresponding to the selected image 422. The device 100 may generate content summary information regarding the photo 420 by combining the selected image 422 with the emotion information indicating joy.

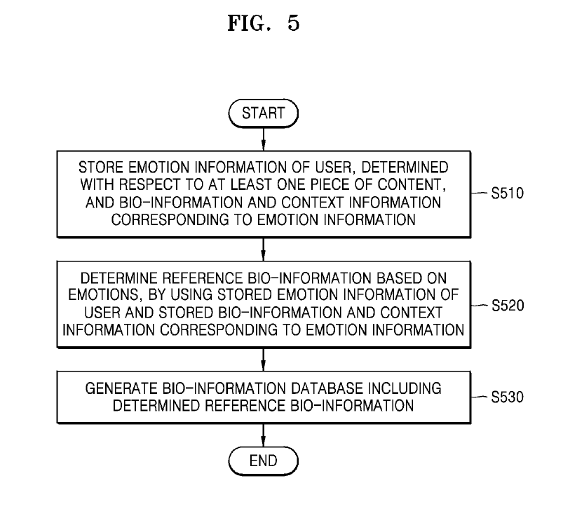

FIG. 5 is a flowchart of a method of generating an emotion information database with respect to a user, via the device 100, according to an embodiment.

In operation S510, the device 100 may store emotion information of a user determined with respect to at least one piece of content, and bio-information and context information corresponding to the emotion information. Here, the bio-information and the context information corresponding to the emotion information refer to bio-information and context information on which the emotion information is determined.

For example, the device 100 may store the bio-information and the context information of the user using at least one piece of content that is output when an application is executed, and the emotion information determined based on the bio-information and the context information. Also, the device 100 may classify the stored emotion information and bio-information corresponding thereto, according to situations, by using the context information.

In operation S520, the device 100 may determine reference bio-information based on emotions, by using the stored emotion information of the user and the stored bio-information and context information corresponding to the emotion information. Also, the device 100 may determine the reference bio-information based on emotions, according to situations of the user. For example, the device 100 may determine an average value of obtained bio-information as the reference bio-information, when a user watches each of films A, B, and C, while walking.

The device 100 may store the reference bio-information that is initially set based on emotions. The device 100 may change the reference bio-information to be suitable for a user, by comparing the reference bio-information that is initially set with obtained bio-information. For example, it may be determined in the initially set reference bio-information that when a user feels interested, an oral angle of a facial expression is raised by 0.5 cm. However, when the user watches each of the films A, B, and C, and the oral angle of the user is raised by 0.7 cm on average, the device 100 may change the reference bio-information such that the oral angle is raised by 0.7 cm when the user feels interested.

In operation S530, the device may generate an emotion information database including the determined reference bio-information. The device 100 may generate the emotion information database in which the reference bio-information based on each emotion that a user feels in each situation is stored. The emotion information database may store the reference bio-information which makes it possible to determine that a user feels a certain emotion in a specific situation.

For example, the emotion information database may store the bio-information with respect to a pulse rate, an amount of sweat, a facial expression, etc., which makes it possible to determine that a user feels fear, joy, or sadness in situations such as when the user is walking or is in a crowded place.

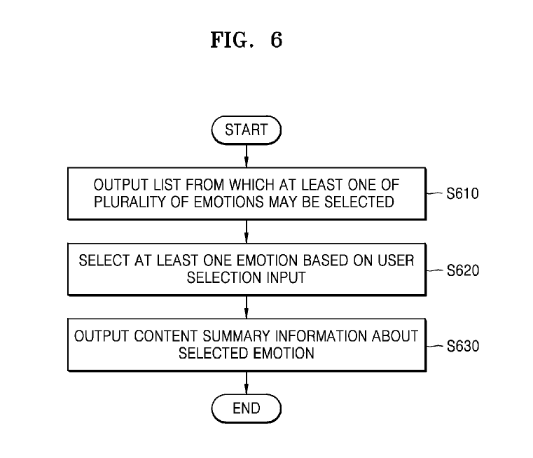

FIG. 6 is a flowchart of a method of providing content summary information with respect to an emotion selected by a user, to the user, via the device 100, according to an embodiment.

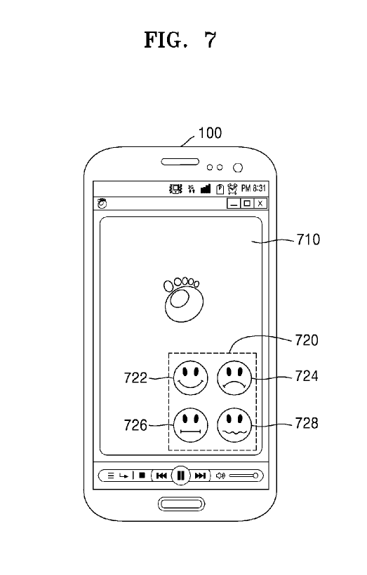

In operation S610, the device 100 may output a list from which at least one of a plurality of emotions may be selected. In the list, at least one of text or images indicating the plurality of emotions may be displayed. This aspect will be described in detail later by referring to FIG. 7.

In operation S620, the device 100 may select at least one emotion based on the selection input of the user. The user may transmit the input of selecting any one of the plurality of emotions displayed via a UI to the device 100.

In operation S630, the device 100 may output the content summary information corresponding to the selected emotion. The content summary information may include at least one portion of content corresponding to the selected emotion and emotion information indicating the selected emotion. Emotion information corresponding to the at least one portion of content may be output in various forms, such as an image, text, etc.

For example, the device 100 may detect at least one piece of content related to the selected emotion, from among pieces of content stored in the device 100. For example, the device 100 may detect a movie, music, a photo, and an e-book related to fear. The device 100 may select any one of the detected pieces of content related to fear, according to a user input. The device 100 may extract at least one portion of content of the selected content. The device 100 may output the extracted at least one portion of content with text or an image indicating the selected emotion.

As another example, when a user specifies types of content, the device 100 may output content related to the selected emotion, from among the specified types of content. For example, when the user specifies the type of content as a film, the device 100 may detect one or more films related to fear. The device 100 may select any one of the detected one or more films related to fear, according to a user input. The device 100 may extract at least one portion of content related to the selected emotion from the selected film. The device 100 may output the extracted at least one portion of content with text or an image indicating the selected emotion.

As another example, when a piece of content is pre-specified, the device 100 may extract at least one portion of content related to a selected emotion from the specified piece of content. The device 100 may output the at least one portion of content extracted from the specified content with text or an image indicating the selected emotion.

However, this is only an embodiment, and the present inventive concept is not limited thereto. For example, when the device 100 receives a request for the content summary information from the user, the device 100 may not select any one emotion, and may provide to the user the content summary information with respect to all emotions.

FIG. 7 is a view for describing a method of providing to the user a UI via which a user may select any one from among a plurality of emotions, via the device 100, according to an embodiment.

The device 100 may display the UI indicating the plurality of emotions that the user may feel, by using at least one of text and an image. Also, the device 100 may provide information about the plurality of emotions to the user by using a sound.

Referring to FIG. 7, when content summary information of content which may be executed on a selected application is generated, the device 100 may provide a UI via which any one emotion may be selected. For example, when a video play application 710 is executed, the device 100 may provide the UI in which emotions, such as fun 722, boredom 724, sadness 726, and fear 728, are displayed as images. The user may select an image corresponding to any one emotion, from among the displayed images, and may receive content related to the selected emotion and the content summary information thereof.

However, this is only an embodiment. When the device 100 re-executes content, the device 100 may provide the UI indicating emotions that the user has felt with respect to the re-executed content. The device 100 may output portions of content with respect to a selected emotion as the content summary information of the re-executed content. For example, when the device 100 re-executes content A, the device 100 may provide the UI in which the emotions that the user has felt with respect to content A are indicated as images. The device 100 may output portions of content A, related to the emotion selected by the user, as the content summary information of content A.

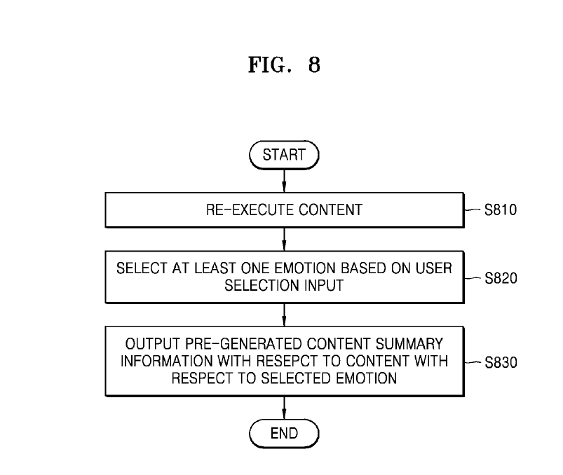

FIG. 8 is a detailed flowchart of a method of outputting content summary information with respect to content, when the content is re-executed by the device 100.

In operation S810, the device 100 may re-execute the content. When the content is re-executed, the device 100 may determine whether there is content summary information. When there is the content summary information with respect to the re-executed content, the device 100 may provide a UI via which any one of a plurality of emotions may be selected.

In operation S820, the device 100 may select at least one emotion based on a selection input of a user.

When the user transmits a touch input on an image indicating any one emotion, via the UI displaying a plurality of emotions, the device 100 may select the emotion corresponding to the touch input.

As another example, the user may input a text indicating a specific emotion on an input window displayed on the device 100. The device 100 may select an emotion corresponding to the input text.

In operation S830, the device 100 may output the content summary information with respect to the selected emotion.

For example, the device 100 may output portions of content related to the selected emotion of fear. When the re-executed content is a video, the device 100 may output scenes to which it is determined that the user feels scared. Also, when the re-executed content is an e-book, the device 100 may output text to which it is determined that the user feels scared. As another example, when the re-executed content is music, the device 100 may output a part of a melody to which it is determined that the user feels sad.

Also, the device 100 may output the portions of content with emotion information with respect to the portions of content. The device 100 may output at least one of text, an image, and a sound indicating the selected emotion, together with the portions of content.

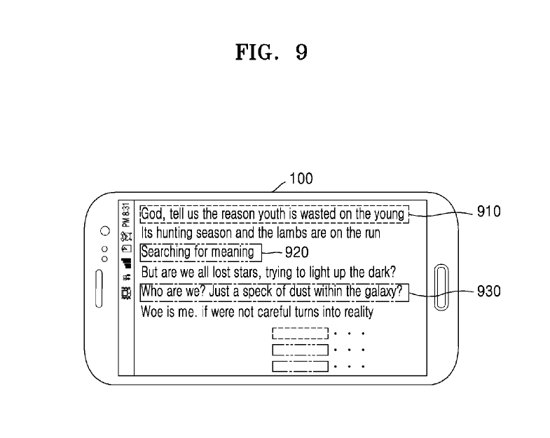

The content summary information that is output by the device 100 will be described in detail by referring to FIGS. 9 through 14.

FIG. 9 is a view for describing a method of providing content summary information, when an e-book is executed on the device 100, according to an embodiment.

Referring to FIG. 9, the device 100 may display highlight marks 910, 920, and 930 on a text portion, with respect to which a user feels a specific emotion, on a page of the e-book displayed on a screen. For example, the device 100 may display the highlight marks 910, 920, and 930 on a text portion with respect to which the user feels an emotion selected by the user. As another example, the device 100 may display the highlight marks 910, 920, and 930 on text portions on the displayed page, the text portions respectively corresponding to a plurality of emotions that the user feels. The device 100 may display the highlight marks 910, 920, and 930 of different colors based on emotions.

For example, the device 100 may display the highlight marks 910 and 930 of a yellow color on a text portion of the e-book page, with respect to which the user feels sadness, and may display the highlight mark 920 of a red color on a text portion of the e-book page, with respect to which the user feels anger. Also, the device 100 may display the highlight marks with different transparencies with respect to the same kind of emotion. The device 100 may display the highlight mark 910 of a light yellow color on a text portion, with respect to which the degree of sadness is relatively low, and may display the highlight mark 920 of a deep yellow color on a text portion, with respect to which the degree of sadness is relatively high.

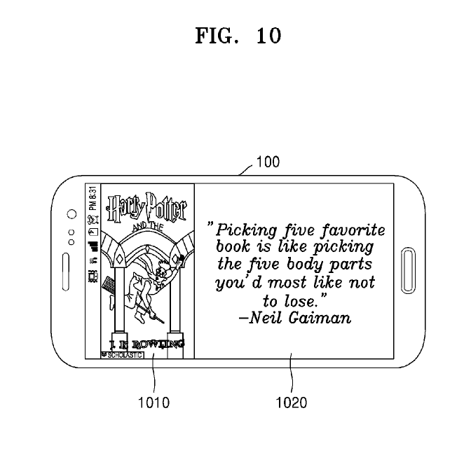

FIG. 10 is a view for describing a method of providing content summary information, when an e-book 1010 is executed on the device 100, according to another embodiment.

Referring to FIG. 10, the device 100 may extract and provide text corresponding to each of a plurality of emotions that a user feels with respect to a displayed page. For example, the device 100 may extract a title page 1010 of the e-book that the user uses and text 1020 to which the user feels sadness, which is the emotion selected by the user, to generate the content summary information regarding the e-book. However, this is only an embodiment, and the content summary information may include only the extracted text 1020 and may not include the title page 1010 of the e-book.

The device 100 may output the generated content summary information regarding the e-book to provide to the user information regarding the e-book.

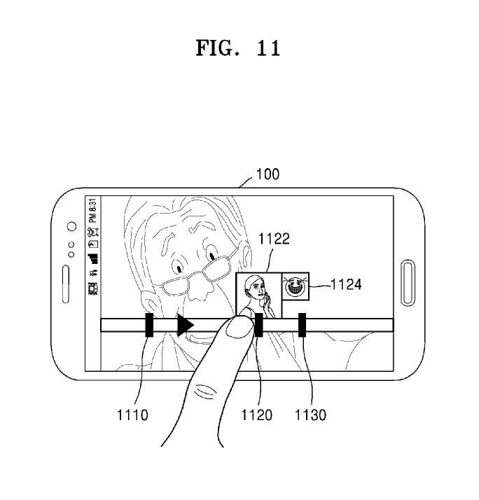

FIG. 11 is a view for describing a method of providing content summary information 1122 and 1124, when a video is executed on the device 100, according to an embodiment.

Referring to FIG. 11, when the video is executed, the device 100 may provide information about scenes of the executed video, with respect to which a user feels a specific emotion. For example, the device 100 may display bookmarks 1110, 1120, and 1130 at positions on a progress bar, the positions corresponding to the scenes, with respect to which the user feels a specific emotion.

The user may select any one of the plurality of bookmarks 1110, 1120, and 1130. The device 100 may display information 1122 regarding the scene corresponding to the selected bookmark 1120, with emotion information 1124. For example, in the case of the video, the device 100 may display a thumbnail image indicating the scene corresponding to the selected bookmark 1120, along with the image 1124 indicating an emotion.

However, this is only an embodiment, and the device 100 may automatically play the scenes on which the bookmarks 1110, 1120, and 1130 are displayed.

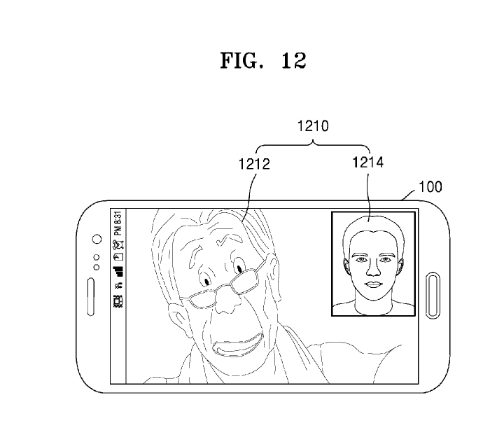

FIG. 12 is a view for describing a method of providing content summary information 1210, when a video is executed on the device 100, according to another embodiment.

The device 100 may provide a scene (for example, 1212) corresponding to a specific emotion, from among a plurality of scenes included in the video, with emotion information 1214. Referring to FIG. 12, when a user using the video feels a specific emotion, the device 100 may provide, as the emotion information 1214 regarding the scene 1212, an image 1214 obtained by photographing a facial expression of the user. The device 100 may display the scene 1212 corresponding to a specific emotion on a screen, and may display the image 1214 obtained by photographing the facial expression of the user, on a side of the screen, overlapping the scene 1212. However, this is only an embodiment, and the device 100 may divide the screen into areas by a certain ratio and display the scene 1212 and the emotion information 1214 on the divided areas, respectively.

However, this is only an embodiment, and the device 100 may provide the emotion information by other methods, rather than providing the emotion information as the image 1214 obtained by photographing the facial expression of the user. For example, when the user feels a specific emotion, the device 100 may record the words or exclamations of the user and provide the recorded words or exclamations as the emotion information regarding the scene 1212.

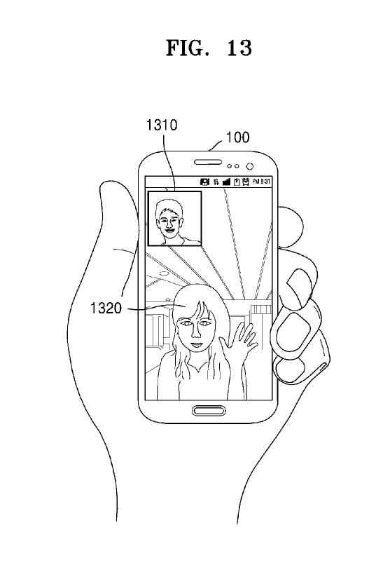

FIG. 13 is a view for describing a method of providing content summary information, when the device 100 executes a call application, according to an embodiment.

The device 100 may record content of a call based on a setting. When the device 100 receives, from a user, a request to generate the content summary information regarding the content of the call, the device 100 may record the content of the call and photograph the facial expression of the user while the user is making a phone call. For example, the device 100 may record a call section with respect to which it is determined that the user feels a specific emotion, and store an image 1310 obtained by photographing a facial expression of the user during the recorded call section.

When the device 100 receives from the user a request to output the content summary information about the content of the call, the device 100 may provide conversation content and the image obtained by photographing the facial expression of the user during the recorded call section. For example, the device 100 may provide the conversation content and the image obtained by photographing the facial expression of the user during the call section at which the user feels pleasure.

Also, when the user performs a video call with the other party, the device 100 may provide not only the conversation content, but also an image 1320 obtained by capturing a facial expression of the other party as a portion of content of the content of the call.

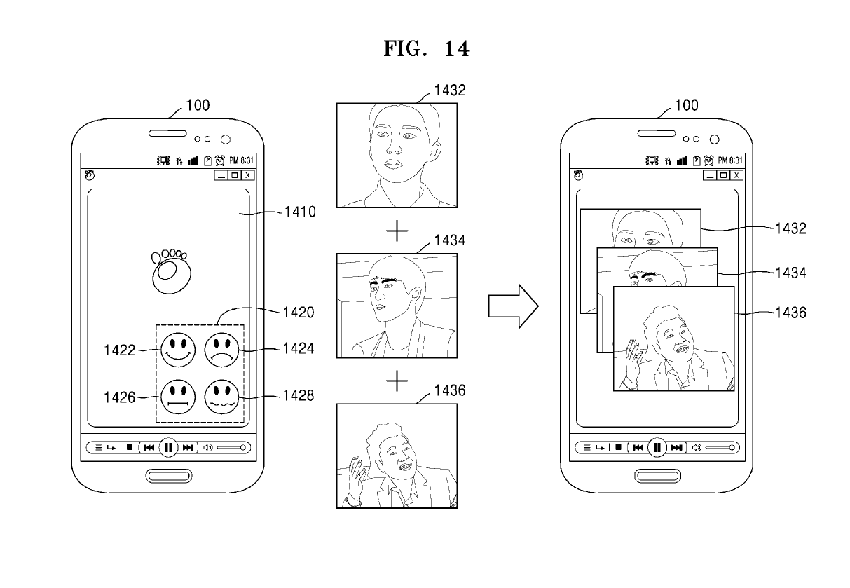

FIG. 14 is a view for describing a method of providing content summary information about a plurality of pieces of content, by combining portion of contents of the plurality of pieces of content, with respect to which a user feels a specific emotion, according to an embodiment.

The device 100 may extract the portions of content, with respect to which the user feels a specific emotion, from portions of content included in the plurality of pieces of content. Here, the plurality of pieces of content may be related to one another. For example, the first piece of content may be movie A which is an original movie, and the second piece of content may be a sequel to movie A. Also, when the pieces of content are included in a drama, the pieces of content may be episodes of the drama.

Referring to FIG. 14, when a video play application is executed, the device 100 may provide a UI 1420 on which emotions, such as joy 1422, boredom 1424, sadness 1426, fear 1428, etc., are indicated as images. When the user selects an image corresponding to any one emotion, from among the plurality of indicated images, the device 100 may provide content related to the selected emotion and the content summary information regarding the content.

For example, the device 100 may capture scenes 1432, 1434, and 1436 with respect to which the user feels joy, from the plurality of pieces of content included in a drama series, and provide the captured scenes 1432, 1434, and 1436 with emotion information. The device 100 may automatically play the captured scenes 1432, 1434, and 1436. As another example, the device 100 may provide thumbnail images of the scenes 1432, 1434, and 1436 with respect to which the user feels fun, with the emotion information.

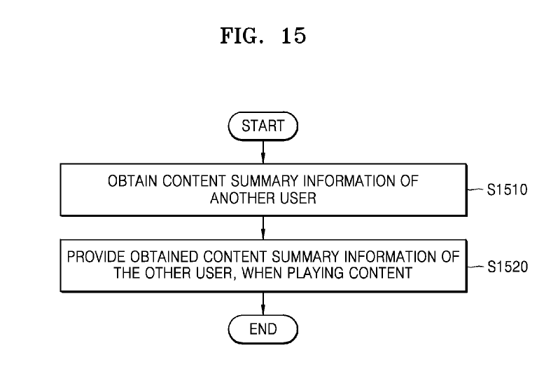

FIG. 15 is a flowchart of a method of providing content summary information of another user, with respect to content, via the device 100, according to an embodiment.

In operation S1510, the device 100 may obtain the content summary information of the other user, with respect to the content.

The device 100 may obtain information of the other user using the content. For example, the device 100 may obtain identification information of a device of the other user using the content and IP information connected to the device of the other user.

The device 100 may request the content summary information about the content, from the device of the other user. The user may select a specific emotion and request the content summary information about the selected emotion. As another example, the user may not select a specific emotion and may request the content summary information about all emotions.

Based on the user's request, the device 100 may obtain the content summary information about the content, from the device of the other user. The content summary information of the other user may include portion of contents with respect to which the other user feels a specific emotion and the emotion information.

In operation S1520, when the device 100 plays the content, the device 100 may provide the obtained content summary information of the other user.

The device 100 may provide the obtained content summary information of the other user with the content. Also, when there is the content summary information including the emotion information of the user with respect to the content, the device 100 may provide the content summary information of the user with the content summary information of the other user.

The device 100 according to an embodiment may provide the content summary information by combining emotion information of the user with emotion information of the other user with respect to a portion of content corresponding to the content summary information of the user. For example, the device 100 may provide the content summary information by combining the emotion information of the user of fear with respect to a first scene of movie A with the emotion information of boredom of the other user with respect to the same.

However, this is only an embodiment, and the device 100 may extract, from the content summary information of the other user, portion of contents which do not correspond to the content summary information of the user, and provide the extracted portion of contents. When emotion information that is different from the emotion information of the user is included in the content summary information of the other user, the device 100 may provide more diverse information about the content, by providing the content summary information of the other user.

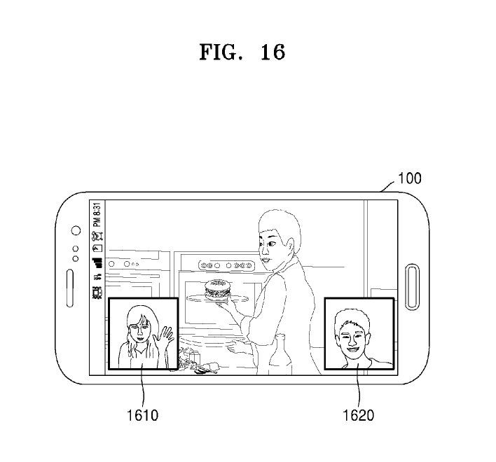

FIG. 16 is a view for describing a method of providing content summary information of another user, with respect to content, via the device 100, according to an embodiment.

When the device 100 plays a video, the device 100 may obtain content summary information 1610 and 1620 of the other user with respect to the video. Referring to FIG. 16, the device 100 may obtain the content summary information 1610 and 1620 of other users using drama A. The content summary information of the other user may include, for example, a scene from a plurality of scenes included in drama A, at which the other user feels a specific emotion, and an image obtained by photographing a facial expression of the other user at the scene in which the other user feels the specific emotion.

When the device 100 according to an embodiment receives a request for information about drama A, from the user, the device 100 may output content summary information of the user, which is pre-generated with respect to drama A. For example, the device 100 may automatically output scenes extracted with respect to a specific emotion, based on the content summary information of the user. Also, the device 100 may extract, from the obtained content summary information of the other user, content summary information corresponding to the extracted scenes, and may output the extracted content summary information together with the extracted scenes.

In FIG. 16, the device 100 may output a scene of drama A, at which the user feels pleasure, with an image obtained by photographing a facial expression of the other user. However, this is only an embodiment, and the device 100 may output the emotion information of the user together with the emotion information of the other user. For example, the device 100 may output the emotion information of the user on a side of a screen, and may output the emotion information of the other user on another side of the screen.

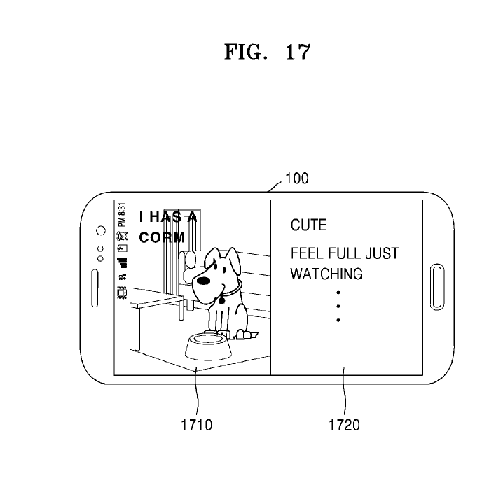

FIG. 17 is a view for describing a method of providing content summary information of another user with respect to content, via the device 100, according to another embodiment.

When the device 100 outputs a photo 1710, the device 100 may obtain content summary information 1720 of the other user with respect to the photo 1710. Referring to FIG. 17, the device 100 may obtain the content summary information 1720 of the other user viewing the photo 1710. The content summary information of the other user may include, for example, emotion information indicating an emotion of the other user with respect to the photo 1710 as text.

When the device 100 according to an embodiment receives a request for information about the photo 1710, from a user, the device 100 may output content summary information of the user, which is pre-generated with respect to the photo 1710. For example, the device 100 may output an emotion that the user feels toward the photo 1710 in the form of text, together with the photo 1710. Also, the device 100 may extract, from the obtained content summary information of the other user, content summary information corresponding to the extracted scenes, and may output the extracted content summary information together with the extracted scenes.

In FIG. 17, the device 100 may output the emotion information of the user with respect to the photo 1710, together with emotion information of the other user, as text. For example, the device 100 may output the photo 1710 on a side of a screen, and output the emotion information 1720 with respect to the photo 1710 on another side of the screen as text, the emotion information 1720 including the emotion information of the user and the emotion information of the other user.

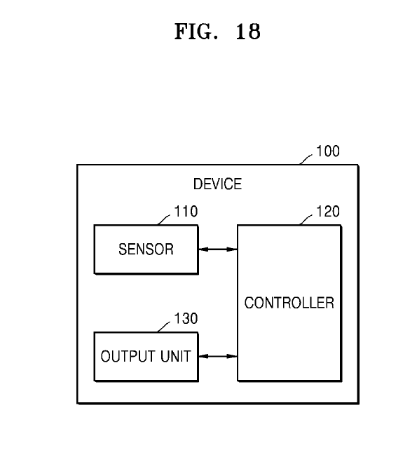

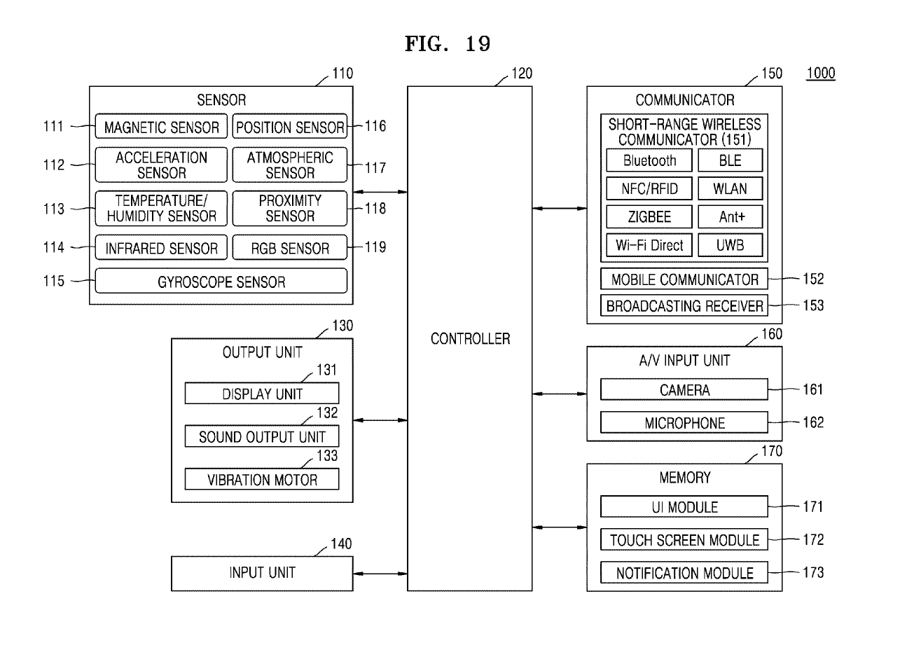

FIGS. 18 and 19 are block diagrams of a structure of the device 100, according to an embodiment.

As illustrated in FIG. 18, the device 100 according to an embodiment may include a sensor 110, a controller 120, and an output unit 130. However, not all of the illustrated components are essential components. The device 100 may be implemented by including more or less components than the illustrated components.

For example, as illustrated in FIG. 19, the device 100 according to an embodiment may further include a user input unit 140, a communicator 150, an audio/video (A/V) input unit 160, and a memory 170, in addition to the sensor 110, the controller 120, and the output unit 130.

Hereinafter, the above components will be sequentially described.

The sensor 110 may sense a state of the device 100 or a state around the device 100, and transfer sensed information to the controller 120.

When content is executed on the device 100, the sensor 110 may obtain bio-information of a user using the executed content and context information indicating a situation of the user at a point of obtaining the bio-information of the user.

The sensor 110 may include at least one of a magnetic sensor 111, an acceleration sensor 112, a temperature/humidity sensor 113, an infrared sensor 114, a gyroscope sensor 115, a position sensor (for example, global positioning system (GPS)) 116, an atmospheric sensor 117, a proximity sensor 118, and an illuminance sensor (an RGB sensor) 119. However, the sensor 110 is not limited thereto. The function of each sensor may be intuitively inferred from its name by one of ordinary skill in the art, and thus, a detailed description thereof will be omitted.

The controller 120 may control general operations of the device 100. For example, the controller 120 may generally control the user input unit 140, the output unit 130, the sensor 110, the communicator 150, and the A/V input unit 160, by executing programs stored in the memory 170.

The controller 120 may determine an emotion of the user using the content, based on the obtained bio-information of the user and the obtained context information, and extract at least one portion of content corresponding to the emotion of the user that satisfies a pre-determined condition. The controller 120 may generate content summary information including the extracted at least one portion of content and emotion information corresponding to the extracted at least one portion of content.

When the bio-information corresponds to reference bio-information that is pre-determined with respect to any one emotion of a plurality of emotions, the controller 120 may determine the emotion as the emotion of the user.

The controller 120 may generate an emotion information database with respect to emotions of the user by using stored bio-information of the user and stored context information of the user.

The controller 120 may determine the emotion of the user, by comparing the obtained bio-information of the user and the obtained context information with bio-information and context information with respect to each of the plurality of emotions stored in the generated emotion information database.

The controller 120 may determine a type of content executed on the device and may determine a portion of content that is extracted, based on the determined type of content.

The controller 120 may obtain content summary information with respect to an emotion selected by a user, with respect to each of a plurality of pieces of content, and combine the obtained content summary information with respect to each of the plurality of pieces of content.

The output unit 130 is configured to perform operations determined by the controller 120 and may include a display unit 130, a sound output unit 132, a vibration motor 133, etc.

The display unit 131 may output information that is processed by the device 100. For example, the display unit 131 may display the content that is executed. Also, the display unit 131 may output the generated content summary information. The display unit 131 may output the content summary information regarding a selected emotion in response to the obtained selection input. The display unit 131 may output the content summary information of a user together with content summary information of another user.

When the display unit 131 and a touch pad form a layer structure to realize a touch screen, the display unit 131 may be used as an input device in addition to an output device. The display unit 131 may include at least one of a liquid crystal display, a thin film transistor-liquid crystal display, an organic light-emitting diode, a flexible display, a three-dimensional (3D) display, and an electrophoretic display. Also, according to an implementation of the device 100, the device 100 may include two or more display units 131. Here, the two or more display units 131 may be arranged to face each other by using a hinge.

The sound output unit 132 may output audio data received from the communicator 150 or stored in the memory 170. Also, the sound output unit 132 may output sound signals (for example, call signal receiving sounds, message receiving sounds, notification sounds, etc.) related to functions performed in the device 100. The sound output unit 132 may include a speaker, a buzzer, etc.

The vibration motor 133 may output a vibration signal. For example, the vibration motor 133 may output vibration signals corresponding to outputs of audio data or video data (for example, call signal receiving sounds, message receiving sounds, etc.) Also, the vibration motor 133 may output vibration signals when a touch is input to a touch screen.

The user input unit 140 refers to a device used by a user to input data to control the device 100. For example, the user input unit 140 may include a key pad, a dome switch, a touch pad (a touch-type capacitance method, a pressure-type resistive method, an infrared sensing method, a surface ultrasonic conductive method, an integral tension measuring method, a piezo effect method, etc.), a jog wheel, a jog switch, etc. However, the input unit 140 is not limited thereto.

The user input unit 140 may obtain a user input. For example, the user input unit 100 may obtain a user selection input for selecting any one emotion of a plurality of emotions. Also, the user input unit 140 may obtain a user input for requesting execution of at least one piece of content from among a plurality of pieces of content that are executable on the device 100.

The communicator 150 may include one or more components that enable communication between the device 100 and an external device or between the device 100 and a server. For example, the communicator 150 may include a short-range wireless communicator 151, a mobile communicator 152, and a broadcasting receiver 153.

The short-range wireless communicator 151 may include a Bluetooth communicator, a Bluetooth low energy communicator, a near field communicator, a WLAN (Wifi) communicator, a Zigbee communicator, an infrared data association (IrDA) communicator, a Wifi direct (WFD) communicator, an ultra-wideband (UWB) communicator, an Ant+ communicator, etc. However, the short-range wireless communicator 151 is not limited thereto.

The mobile communicator 152 may exchange wireless signals with at least one of a base station, an external device, and a server, through a mobile communication network. Here, the wireless signals may include various types of data based on an exchange of a voice call signal, a video call signal, or a text/multimedia message.

The broadcasting receiver 153 may receive a broadcasting signal and/or information related to broadcasting from the outside via a broadcasting channel. The broadcasting channel may include a satellite channel and a ground wave channel. According to an embodiment, the device 100 may not include the broadcasting receiver 153.

The communicator 150 may share with the external device 200 a result of performing an operation corresponding to generated input pattern information. Here, the communicator 150 may transmit, to the external device 200 via the server 300, the result of performing the operation corresponding to the generated input pattern information, or may directly transmit the result of performing the operation corresponding to the generated input pattern information to the external device 200.

The communicator 150 may receive from the external device 200 a result of performing the operation corresponding to the generated input pattern information. Here, the communicator 150 may receive, from the external device 200 via the server 300, the result of performing the operation corresponding to the generated input pattern information, or may directly receive, from the external device 200, the result of performing the operation corresponding to the generated input pattern information.

The communicator 150 may receive a call connection request from the external device 200.

The A/V input unit 160 is configured to input an audio signal or a video signal, and may include a camera 161, a microphone 162, etc.

The camera 161 may obtain an image frame, such as a still image or a video, via an image sensor in a video call mode or a photographing mode. An image captured by the image sensor may be processed by the controller 120 or an additional image processor (not shown).

The image frame obtained by the camera 161 may be stored in the memory 170 or transferred to the outside via the communicator 150. According to an embodiment, the device 100 may include two or more cameras 161.

The microphone 162 may receive an external sound signal and process the received external sound signal into electrical sound data. For example, the microphone 162 may receive a sound signal from an external device or a speaker. The microphone 162 may use various noise removal algorithms to remove noise generated in the process of receiving external sound signals.

The memory 170 may store programs for processing and controlling the controller 120, or may store data that is input or output (for example, a plurality of menus, a plurality of first hierarchical sub-menus respectively corresponding to the plurality of menus, a plurality of second hierarchical sub-menus respectively corresponding to the plurality of first hierarchical sub-menus, etc.)

The memory 170 may store bio-information of a user with respect to at least one portion of content, and context information of the user. Also, the memory 170 may store a reference emotion information database. The memory 170 may store content summary information.

The memory 170 may include at least one type of storage medium of a flash memory type, a hard disk type, a multimedia card micro type, a card type (for example, SD or XD memory), random-access memory (RAM), static random-access memory (SRAM), read-only memory (ROM), electrically erasable programmable read-only memory (EEPROM), programmable read-only memory (PROM), magnetic memory, a magnetic disk, and an optical disk. Also, the device 100 may operate web storage or a cloud server that performs a storage function of the memory 170 through the Internet.

The programs stored in the memory 170 may be divided into a plurality of modules based on functions thereof. For example, the programs may be divided into a user interface (UI) module 171, a touch screen module 172, a notification module 173, etc.

The UI module 171 may provide UIs, graphic UIs, etc. that are specified for applications in connection with the device 100. The touch screen module 172 may sense a touch gesture of a user on a touch screen and transfer information about the touch gesture to the controller 120. The touch screen module 172 according to an embodiment may recognize and analyze a touch code. The touch screen module 172 may be formed as additional hardware including a controller.

Various sensors may be provided in or around the touch screen to sense a touch or a proximate touch on the touch screen. As an example of the sensor for sensing a touch on the touch screen, there is a touch sensor. The touch sensor refers to a sensor that is configured to sense a touch of a specific object to the degree or over the degree to which a human senses. The touch sensor may sense a variety of information related to roughness of a contact surface, rigidity of a contacting object, a temperature of a contact point, etc.

Also, as another example of the sensor for sensing a touch on the touch screen, there is a proximity sensor.

The proximity sensor refers to a sensor that is configured to sense whether there is an object approaching or around a predetermined sensing surface by using a force of an electromagnetic field or infrared rays, without mechanical contact. Examples of the proximity sensor include a transmissive photoelectric sensor, a direct-reflective photoelectric sensor, a mirror-reflective photoelectric sensor, a high-frequency oscillating proximity sensor, a capacitance proximity sensor, a magnetic-type proximity sensor, an infrared proximity sensor, etc. The touch gesture of a user may include tapping, touching & holding, double tapping, dragging, panning, flicking, dragging and dropping, swiping, etc.

The notification module 173 may generate a signal for notifying occurrence of an event of the device 100. Examples of the occurrence of an event of the device 100 may include receiving a call signal, receiving a message, inputting a key signal, schedule notification, obtaining a user input, etc. The notification module 173 may output a notification signal as a video signal via the display unit 131, as an audio signal via the sound output unit 132, or as a vibration signal via the vibration motor 133.

The method of the present inventive concept may be implemented as computer instructions which may be executed by various computer means, and recorded on a computer-readable recording medium. The computer-readable recording medium may include program commands, data files, data structures, or a combination thereof. The program commands recorded on the computer-readable recording medium may be specially designed and constructed for the inventive concept or may be known to and usable by one of ordinary skill in a field of computer software. Examples of the computer-readable medium include storage media such as magnetic media (e.g., hard discs, floppy discs, or magnetic tapes), optical media (e.g., compact disc-read only memories (CD-ROMs), or digital versatile discs (DVDs)), magneto-optical media (e.g., floptical discs), and hardware devices that are specially configured to store and carry out program commands (e.g., ROMs, RAMs, or flash memories). Examples of the program commands include a high-level language code that may be executed by a computer using an interpreter as well as a machine language code made by a complier.

According to the one or more of the above embodiments, the device 100 may provide a user interaction via which an image card indicating a state of a user may be generated and shared. In other words, the device 100 may enable the user to generate the image card indicating the state of the user and to share the image card with friends, via the simple user interaction.

While the present inventive concept has been particularly shown and described with reference to example embodiments thereof, it will be understood by one of ordinary skill in the art that various changes in form and details may be made therein without departing from the spirit and scope of the present inventive concept as defined by the following claims. Hence, it will be understood that the embodiments described above are not limiting of the scope of the invention. For example, each component described in a single type may be executed in a distributed manner, and components described distributed may also be executed in an integrated form.

The scope of the present inventive concept is indicated by the claims rather than by the detailed description of the invention, and it should be understood that the claims and all modifications or modified forms drawn from the concept of the claims are included in the scope of the present inventive concept.

1. A method of providing content, via a device, the method comprising:
obtaining bio-information of a user using content executed on the device, and context information indicating a situation of the user at a point of obtaining the bio-information of the user;
determining an emotion of the user using the content, based on the obtained bio-information of the user and the obtained context information of the user;
extracting at least one portion of content corresponding to the emotion of the user that satisfies a predetermined condition; and
generating content summary information including the extracted at least one portion of content, and emotion information corresponding to the extracted at least one portion of content.

2. The method of claim 1, wherein the determining of the emotion of the user using the content comprises, when the bio-information corresponds to reference bio-information that is predetermined with respect to any one emotion of a plurality of emotions, determining the one emotion as the emotion of the user.

3. The method of claim 1, further comprising:
storing the bio-information of the user and the context information of the user with respect to the at least one portion of content included in each of a plurality of pieces of content; and
generating an emotion information database regarding the emotion of the user by using the stored bio-information of the user and the stored context information of the user.

4. The method of claim 3, wherein the determining of the emotion of the user using the content comprises determining the emotion of the user, by comparing the obtained bio-information of the user and the obtained context information of the user with bio-information and context information with respect to each of a plurality of emotions stored in the generated emotion information database.

5. The method of claim 1, wherein the extracting of the at least one portion of content comprises:
determining a type of the content executed on the device; and
determining the extracted at least one portion of content based on the determined type of the content.

6. The method of claim 5, further comprising:
obtaining the content summary information with respect to a determined emotion from each of a plurality of pieces of content; and
combining the obtained content summary information of each of the plurality of pieces of content and outputting the combined content summary information.

7. The method of claim 1, further comprising:
obtaining content summary information of another user with respect to the content; and
outputting the content summary information of the user together with the content summary information of the other user.

8. A device for providing content, the device comprising:
a sensor configured to obtain bio-information of a user using content executed on the device and context information indicating a situation of the user at a point of obtaining the bio-information of the user;
a controller configured to determine an emotion of the user using the content, based on the obtained bio-information of the user and the obtained context information of the user, extract at least one portion of content corresponding to the emotion of the user that satisfies a predetermined condition, and generate content summary information including the extracted at least one portion of content, and emotion information corresponding to the extracted at least one portion of content; and
an output unit configured to display the executed content.

9. The device of claim 8, wherein when the bio-information corresponds to reference bio-information that is predetermined with respect to any one emotion of a plurality of emotions, the controller is further configured to determine the one emotion as the emotion of the user.

10. The device of claim 8, further comprising:
a memory configured to store the bio-information of the user and the context information of the user with respect to the at least one portion of content included in each of a plurality of pieces of content,
wherein the controller is further configured to generate an emotion information database regarding the emotion of the user by using the stored bio-information of the user and the stored context information of the user.

11. The device of claim 10, wherein the controller is further configured to determine the emotion of the user, by comparing the obtained bio-information of the user and the obtained context information of the user with bio-information and context information with respect to each of a plurality of emotions stored in the generated emotion information database.

12. The device of claim 8, wherein the controller is further configured to determine a type of the content executed on the device, and based on the determined type of the content, determine the extracted at least one portion of content.

13. The device of claim 12, wherein the controller is further configured to obtain the content summary information with respect to a determined emotion from each of a plurality of pieces of content, and combine the obtained content summary information of each of the plurality of pieces of content, and
the output unit is configured to output the combined content summary information.

14. The device of claim 8, further comprising:
a communicator configured to obtain content summary information of another user with respect to the content,
wherein the output unit is configured to output the content summary information of the user together with the content summary information of the other user.

15. A non-transitory computer-readable recording medium having recorded thereon at least one program comprising commands, which when executed by a computer, performs a method, the method comprising:
obtaining bio-information of a user using content executed on the device, and context information indicating a situation of the user at a point of obtaining the bio-information of the user;
determining an emotion of the user using the content, based on the obtained bio-information of the user and the obtained context information of the user;
extracting at least one portion of content corresponding to the emotion of the user that satisfies a predetermined condition; and
generating content summary information including the extracted at least one portion of content, and emotion information corresponding to the extracted at least one portion of content.

16. The non-transitory computer-readable recording medium of claim 15, wherein the determining of the emotion of the user using the content comprises, when the bio-information corresponds to reference bio-information that is predetermined with respect to any one emotion of a plurality of emotions, determining the one emotion as the emotion of the user.

17. The non-transitory computer-readable recording medium of claim 15, wherein the method further comprises:
storing the bio-information of the user and the context information of the user with respect to the at least one portion of content included in each of a plurality of pieces of content; and
generating an emotion information database regarding the emotion of the user by using the stored bio-information of the user and the stored context information of the user.

18. The non-transitory computer-readable recording medium of claim 17, wherein the determining of the emotion of the user using the content comprises determining the emotion of the user, by comparing the obtained bio-information of the user and the obtained context information of the user with bio-information and context information with respect to each of a plurality of emotions stored in the generated emotion information database.

19. The non-transitory computer-readable recording medium of claim 15, wherein the extracting of the at least one portion of content comprises:
determining a type of the content executed on the device; and
determining the extracted at least one portion of content based on the determined type of the content.

20. The non-transitory computer-readable recording medium of claim 15, wherein the method further comprises:
obtaining content summary information of another user with respect to the content; and
outputting the content summary information of the user together with the content summary information of the other user.
